(19) United States
(12) Patent Application Publication
(10) Pub. No.: US 2010/0238274 A1
(43) Pub. Date: Sep. 23, 2010

(54) METHOD OF DISPLAYING THREE-DIMENSIONAL IMAGE DATA AND AN APPARATUS OF PROCESSING THREE-DIMENSIONAL IMAGE DATA

(75) Inventors: Hak Tae KIM, Seoul (KR); Keun Bok SONG, Seoul (KR); Seung Jong CHOI, Seoul (KR)

Correspondence Address: KED & ASSOCIATES, LLP, P.O. Box 221200, Chantilly, VA, 20153-1200, US

(73) Assignee: LG Electronics Inc., Seoul (KR)

(21) Appl. No.: 12/724,786

(22) Filed: Mar. 16, 2010

Related U.S. Application Data
(60) Provisional application No. 61/173,985, filed on Apr. 30, 2009.

(30) Foreign Application Priority Data
Mar. 16, 2009 (KR) 10-2009-0022382

(51) Int. Cl. H04N 13/04

(52) U.S. Cl. 348/51; 348/E15.001

(57) ABSTRACT

A method is provided that includes receiving a three-dimensional (3D) image signal, generating image data from the 3D image signal, wherein said image data includes a plurality of left image data and a plurality of right image data, configuring the generated 3D image data to a 3D format, wherein the configured 3D image data includes black data and displaying the configured 3D image data at an output frequency, wherein the output frequency is synchronized with a shutter glasses.

This application claims priority and benefit from Korean application No. 10-2009-0022382, filed Mar. 16, 2009, the subject matter of which is hereby incorporated by reference. Also, this application claims priority and benefit from U.S. Provisional Application No. 61/173,985, filed Apr. 30, 2009, the subject matter of which is hereby incorporated by reference.

### BACKGROUND

1. Field

The present invention relates to an apparatus and a method for processing and displaying an image signal, and more particularly to a reception system for receiving, processing and displaying a three-dimensional (3D) image signal, and a method thereof.

2. Background

In recent times, demand and interest in a three-dimensional (3D) display are rapidly increasing. Also, a large number of movies manufactured in Hollywood have been projected and manufactured in 3D. As a result, demand for display devices capable of displaying 3D content (or 3D video signals) is rapidly increasing.

The above-mentioned rapidly increasing demand and interest in such 3D content will expedite the appearance of the new trend for enabling a user who views the 3D content to freely view a desired 3D image at home.

However, unexpected problems such as crosstalk or unsatisfactory luminance may occur in a 3D image (i.e., 3D content data) displayed on a conventional display device, such that the user who views the 3D image may experience discomfort when viewing the displayed 3D image.

### SUMMARY OF THE INVENTION

An object of the present invention is directed to a method for displaying three-dimensional (3D) image data and an apparatus for processing 3D image data that substantially obviate one or more problems due to limitations and disadvantages of the related art.

Another object of the present invention is to provide a method for reducing crosstalk and luminance deterioration during an output process of 3D image data.

To achieve the object, one embodiment of the present invention discloses a method of displaying an image. The method includes receiving a three-dimensional (3D) image signal, generating image data from the 3D image signal, wherein said image data includes a plurality of left image data and a plurality of right image data, configuring the generated 3D image data to a 3D format, wherein the configured 3D image data includes black data and displaying the configured 3D image data at an output frequency, wherein the output frequency is synchronized with a shutter glasses.

The method may further comprise controlling a power of a backlight unit.

The step of controlling the power of the backlight unit may be performed at some part of a period being displayed 3D image data.

The some part can be overlapped with a part of displaying the black data.

The step of controlling the power of the backlight unit may be performed by any one of a backlight scanning and a backlight blinking.

In another aspect, one embodiment of the present invention discloses a method of displaying an image. The method includes receiving a three-dimensional (3D) image signal, generating image data from the 3D image signal, wherein said image data includes a plurality of first image data and a plurality of second image data, configuring the generated 3D image data to a 3D format, displaying the configured 3D image data at an output frequency, wherein the output frequency is synchronized with a shutter glasses and controlling a power of a backlight at some part of a period being displayed 3D image data.

The configured 3D image data may include black data.

The generated black data may be configured for configured 3D format.

The some part of a period being displayed 3D image data can be overlapped with the black data.

The step of controlling the power of the backlight unit may be performed by any one of a backlight scanning and a backlight blinking.

In another aspect, one embodiment of the present invention discloses a method of displaying an image. The method includes receiving an image signal by a signal processor, processing the image signal into a left image data and a right image data, processing the left image data and right image data into a frame, generating a plurality of frames based upon the frame, formatting the generated plurality of frames into at least one left frames and at least one right frames, displaying the formatted at least one left frames and the formatted at least one right frames, controlling a power of a backlight at some part of a period being displayed the at least one left frames and at least one right frames and synchronizing a frequency of a user glasses with a frequency of the displayed at least one left frames and at least one right frames.

One of the left frames may be a frame having black data and one of the right frame having black data.

The displayed the formatted at least one left frames and the formatted at least one right frames may become substantially black of the black frames of the right frames and the left frames.

In another aspect, one embodiment of the present invention discloses an apparatus of processing three-dimensional (3D) image data. The apparatus includes a receiving unit for receiving a 3D image signal, a Frame Rate Converter (FRC) unit for generating image data from the 3D image signal, wherein the image data includes a plurality of first image data and a plurality of second image data, a formatter for configuring the generated 3D image data to a 3D format, wherein the configured 3D image data includes black data and a display unit for displaying the configured 3D image data at an output frequency, wherein the output frequency is synchronized with a shutter glasses.

The apparatus may further comprise a controller for controlling a power of a backlight unit in the display unit.

The controller may control to be performed at some part of a period being displayed 3D image data.

The controller may control the some part of a period being displayed 3D image data to be overlapped with a part of displaying the black data.

In another aspect, one embodiment of the present invention discloses an apparatus of processing three-dimensional (3D) image data. The apparatus includes a receiving unit for receiving a 3D image signal, a Frame Rate Converter (FRC) unit for generating image data from the 3D image signal, wherein said image data includes a plurality of first image data and a plurality of second image data, a formatter for configuring the generated 3D image data to a 3D format, a display unit for displaying the configured 3D image data at an output frequency, wherein the output frequency is synchronized with a shutter glasses and a controller for controlling a power of a backlight at some part of a period being displayed 3D image data.

The controller may control the configured 3D image data to include black data.

The controller may control the some part of a period being displayed 3D image data to be overlapped with a part of displaying the black data.

### BRIEF DESCRIPTION OF THE DRAWINGS

Arrangements and embodiments may be described in detail with reference to the following drawings in which like reference numerals refer to like elements and wherein:

FIG. 1 shows examples of a single video stream format among transport formats of a stereoscopic image according to embodiments of the present invention;

FIG. 2 shows examples of a multiple video stream format among transport formats of a stereoscopic image according to embodiments of the present invention;

FIG. 3 is a conceptual diagram illustrating that a user views 3D image data displayed on a CRT display device 310 using shutter glasses 320 according to embodiments of the present invention;

FIGS. 4 to 6 are conceptual diagrams illustrating a correlation between each display device and crosstalk according to embodiments of the present invention;

FIG. 7 is a conceptual diagram illustrating a method for improving crosstalk generated in an LCD display device according to embodiments of the present invention;

FIG. 8 is a block diagram illustrating a system for processing an image signal according to embodiments of the present invention;

FIG. 9 is a conceptual diagram illustrating a method for processing 3D image data in the FRC unit 820 according to embodiments of the present invention;

FIG. 10 is a conceptual diagram illustrating a method for configuring 3D image data according to one embodiment of the present invention;

FIG. 11 is a conceptual diagram illustrating a method for displaying 3D image data having arrangements shown in FIGS. 10(a) to 10(c) according to one embodiment of the present invention;

FIG. 12 shows an example of a backlight control method according to one embodiment of the present invention;

FIG. 13 shows another example of a backlight control method according to one embodiment of the present invention;

FIG. 14 shows another example of a method for controlling the backlight unit according to the present invention;

FIG. 15 is a conceptual diagram illustrating a method for constructing 3D image data according to yet another embodiment of the present invention;

FIG. 16 is a flowchart illustrating a method for processing image data according to one embodiment of the present invention; and

FIG. 17 is a flowchart illustrating a method for processing image data according to another embodiment of the present invention.

### DETAILED DESCRIPTION

Reference may now be made in detail to preferred embodiments of the present invention, examples of which may be illustrated in the accompanying drawings. The same reference numbers may be used throughout the drawings to refer to the same or like parts. In addition, although the terms are selected from generally known and used terms, some of the terms mentioned in the description of embodiments have been selected by the applicant at his or her discretion, the detailed meanings of which may be described in relevant parts of the description herein. Further, embodiments of the present invention may be understood, not simply by the actual terms used but by the meaning of each term lying within.

Embodiments of the present invention provide not only a 3D image data processing method for reducing crosstalk and luminance deterioration generated in an operation process of a display device capable of displaying 3D image data, but also a 3D image data processing apparatus for processing 3D image data using the above-mentioned 3D image data processing method.

For convenience of description and better understanding of the present invention, a display device for use in a system capable of processing 3D image data will be described using an active scheme for sequentially displaying left image data (i.e., a left view image) and right image data (i.e., a right view image) as an example.

In association with embodiments of the present invention, a 3D image will be described in detail.

A variety of 3D images may be used in the embodiments of the present invention, for example, a stereoscopic image (also called a stereo image) for utilizing two view points and a multiple view image (also called a multi-view image) for utilizing three or more view points.

The stereoscopic image may indicate one pair of right view image and left view image acquired when a left-side camera and a right-side camera spaced apart from each other by a predetermined distance capture the same target object. The multi-view image may indicate three or more images captured by three or more cameras spaced apart by a predetermined distance or angle.

A variety of transport formats may be used for the stereoscopic image disclosed in the above-mentioned description, for example, a single video stream format, a multiple video stream format (also called a multi-video stream format), etc.

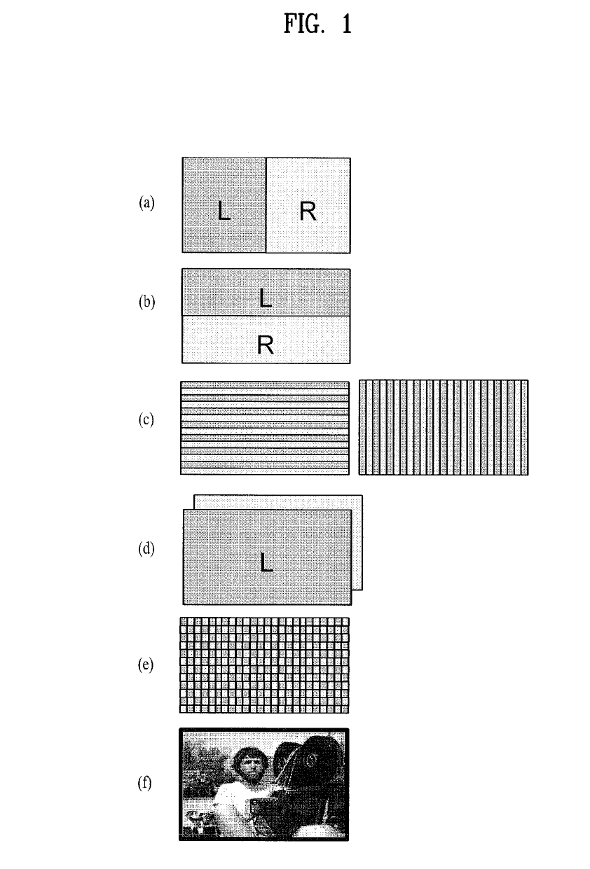

There are a variety of single video stream formats, for example, a side-by-side format shown in FIG. 1(a), a top/down format shown in FIG. 1(b), an interlaced format shown in FIG. 1(c), a frame sequential format shown in FIG. 1(d), a checker board format shown in FIG. 1(e), an anaglyph format shown in FIG. 1(f), etc.

In accordance with the side-by-side format shown in FIG. 1(a), each of left image data (also called left view data) and right image data (also called right view data) is ½ sub-sampled in a horizontal direction, the sampled left image data is located at the left side of a display screen, and the sampled right image data is located at the right side of the display screen, so that a single stereoscopic image is formed.

In accordance with the top/down format shown in FIG. 1(b), each of the left image data and the right image data is ½ sub-sampled in a vertical direction, the sampled left image data is located at an upper part of a display screen, and the sampled right image data is located at a lower part of the display screen, so that a single stereoscopic image is formed.

In accordance with the interlaced format shown in FIG. 1(c), each of the left image data and the right image data is ½ sub-sampled in a vertical direction, and a pixel of the sampled left image data and a pixel of the sampled right image data are alternately arranged at each line so that a stereoscopic image is formed. In addition, each of the left image data and the right image data is ½ sub-sampled in a horizontal direction, and a pixel of the sampled left image data and a pixel of the sampled right image data are alternately arranged so that a stereoscopic image is formed.

In accordance with the frame sequential format shown in FIG. 1(d), left image data and right image data are not sub-sampled, and the left image data and the right image data are sequentially and alternately arranged so that a stereoscopic image is formed.

In accordance with the checker board format shown in FIG. 1(e), left image data and right image data are ½ sub-sampled in vertical and horizontal directions, respectively, and a pixel of the sampled left image data and a pixel of the sampled right image data are alternately arranged so that a stereoscopic image is formed.

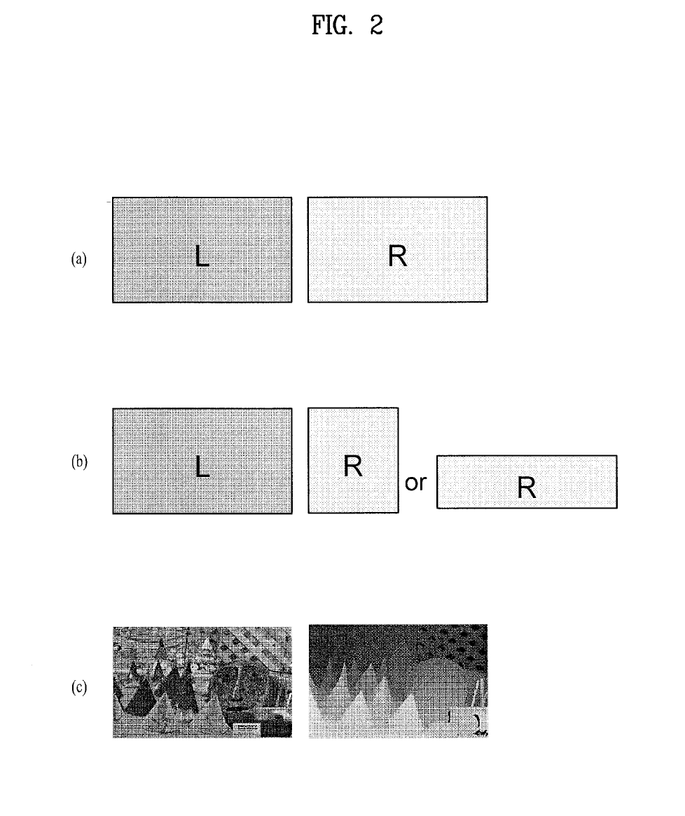

A variety of multiple video stream formats may be used, for example, a full left/right format shown in FIG. 2(a), a full left/half right format shown in FIG. 2(b), a 2D video/depth format shown in FIG. 2(c), etc.

The full left/right format shown in FIG. 2(a) shows an exemplary case in which left image data and right image data are sequentially transmitted, and the full left/half right format shown in FIG. 2(b) shows an exemplary case in which left image data is transmitted without any change and right image data is ½ sub-sampled in a vertical or horizontal direction and the sub-sampled right image data is then transmitted. The 2D video/depth format shown in FIG. 2(c) shows an exemplary case in which one of the left image data and the right image data and depth information for constructing the other one are simultaneously transmitted.

A stereoscopic image or a multi-view image may be compressed and coded according to a variety of methods including a Moving Picture Experts Group (MPEG) scheme, and transmitted to a reception system.

For example, the stereoscopic image, for example, the side by side format, the top/down format, the interlaced format, the frame sequential format, or the checker board format, may be compressed and coded according to the H.264/Advanced Video Coding (AVC) scheme, and transmitted. In this case, the reception system may decode the stereoscopic image in reverse order of the H.264/AVC coding scheme, such that it can obtain the 3D image.

In addition, one of left view images of the full left/half right format or one of multi-view images may be assigned to an image of a base layer, and the remaining images may be assigned to an image of an enhanced layer. The base layer image may be encoded using the same method as the monoscopic imaging method. In association with the enhanced layer image, only information of a correlation between the base layer image and the enhanced layer image may be encoded and transmitted. As an exemplary compression coding scheme for the base layer image, a Joint Photographic Experts Group (JPEG), an MPEG-1, an MPEG-2, an MPEG-4, or a H.264/AVC scheme may be used. In one embodiment of the present invention, the H.264/Multi-view Video Coding (MVC) scheme may be used as the compression coding scheme for the enhanced layer image. In this case, the stereoscopic image may be assigned to a base layer image and a single enhanced layer image, but the multi view image may be assigned to a single base layer image and a plurality of enhanced layer images. A reference for discriminating between the base layer image and at least one enhanced layer image may be determined according to a position of a camera, or may be determined according to an arrangement format of the camera. Alternatively, the base layer image and the at least one enhanced layer image may also be distinguished from each other on the basis of an arbitrary reference instead of a special reference.

Generally, a 3D image provides a user with a stereoscopic effect using the stereoscopic visual principle. A human being senses depth through a binocular parallax caused by a distance between the eyes, which are spaced apart from each other by about 65 mm, such that the 3D image enables both right and left eyes to respectively view associated planar images, and a human brain merges two different images with each other, resulting in a sense of depth and a sense of reality in the 3D image.

The above-mentioned 3D image display method may be classified into a stereoscopic scheme, a volumetric scheme, a holographic scheme, etc. In addition, a 3D image display device adds depth information to two dimensional (2D) images, such that a user of the 3D image display device can feel a sense of vividness and a sense of reality in a 3D image.

In addition, a method for allowing the user to view the 3D image may be exemplarily classified into a first method for providing the user with glasses and a second method where the user does not wear glasses.

The first method for providing the user with polarized glasses is classified into a passive scheme and an active scheme. The passive scheme displays a left view image and a right view image using a polarization filter in different ways. The active scheme can discriminate between a left view image and a right view image using a liquid crystal shutter. In more detail, the left view image (i.e., a user's left eye) and the right view image (i.e., a user's right eye) are sequentially covered according to the active scheme, such that the left view image and the right view image can be distinguished from each other. That is, the active scheme repeatedly displays screen images created by time division at intervals of a predetermined time period, and allows a user who wears glasses including an electronic shutter synchronized with the predetermined time period to view a 3D image. The active scheme may also be called a scheme of a time split type or a scheme of a shuttered glass type.

Representative examples of the second scheme where the user does not wear glasses are a lenticular scheme and a parallax barrier scheme. In accordance with the lenticular scheme, a lenticular lens plate in which a cylindrical lens array is vertically arranged is installed in front of a video panel. In accordance with the parallax barrier scheme, a barrier layer including periodic slits is installed on the video panel.

In order to more easily explain the technical idea of the present invention, a stereoscopic scheme among 3D display schemes will be used as an example, and the active scheme among stereoscopic schemes will be used as an example. However, although the shutter glasses will be used as an exemplary medium of the active scheme, the scope and spirit of the present invention are not limited thereto, and can also be applied to other mediums as necessary without departing from the spirit or scope of the present invention.

In accordance with the active scheme as described above, in the case where left image data for a user's left eye is displayed, a left shutter of the shutter glasses is opened. In the case where right image data for a user's right eye is displayed, a right shutter of the shutter glasses is opened.

The above-mentioned scheme for utilizing individual glasses of the shutter glasses has been widely used for 3D display devices, each of which uses a monitor including a Cathode Ray Tube (CRT) display device.

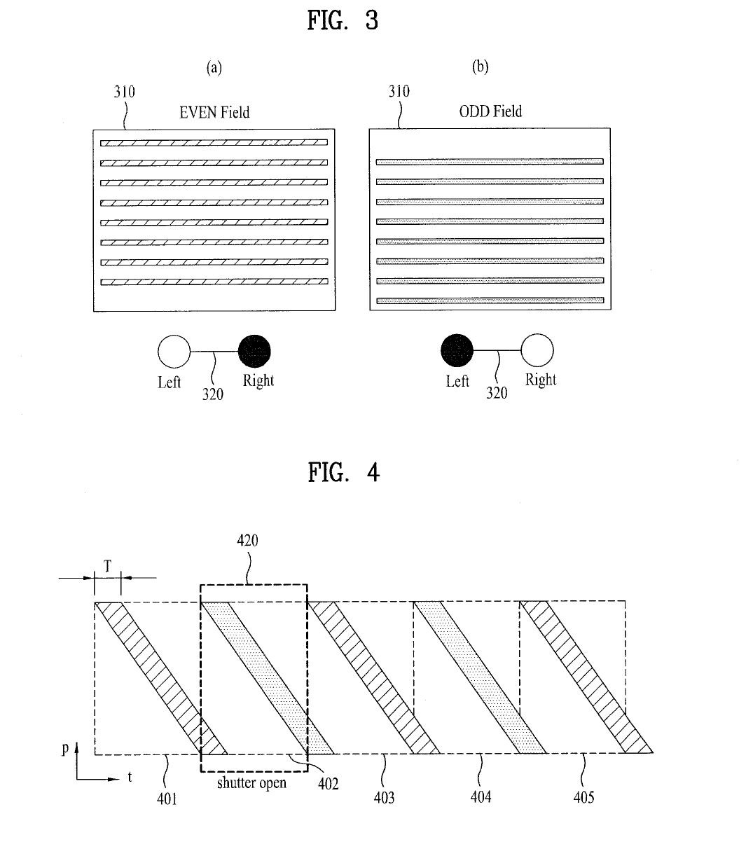

FIG. 3 is a conceptual diagram illustrating that a user views 3D image data displayed on a CRT display device 310 using shutter glasses 320 according to embodiments of the present invention.

As shown in FIG. 3(a), the CRT display device 310 includes an even field and an odd field. In this case, image data for the left eye is displayed on the even field. Therefore, in the case of using the even field, the left shutter of the shutter glasses 320 is opened and the right shutter is closed, so that the user can view the displayed left view image data using the even field. In contrast, in the case of using the odd field, the right shutter of the shutter glasses 320 is opened and the left shutter is closed, so that the user can view the displayed right view image data using the odd field.

In the case where the user views a 3D image using the shutter glasses 320, for example, in the case where the left shutter of the shutter glasses 320 is opened, only the left image data for the user's left eye should be displayed on a display screen, but the right image data for the user's right eye is actually displayed on some parts of the display screen, so that the user may experience discomfort when viewing a 3D image, resulting in crosstalk in the displayed 3D image. The crosstalk indicates a specific phenomenon wherein original image data and unexpected image data are simultaneously displayed on the display screen, resulting in a deterioration in image quality. The presence or absence of crosstalk or the degree of crosstalk may be differently determined according to operation principles, characteristics, shutter glasses of individual display devices, etc.

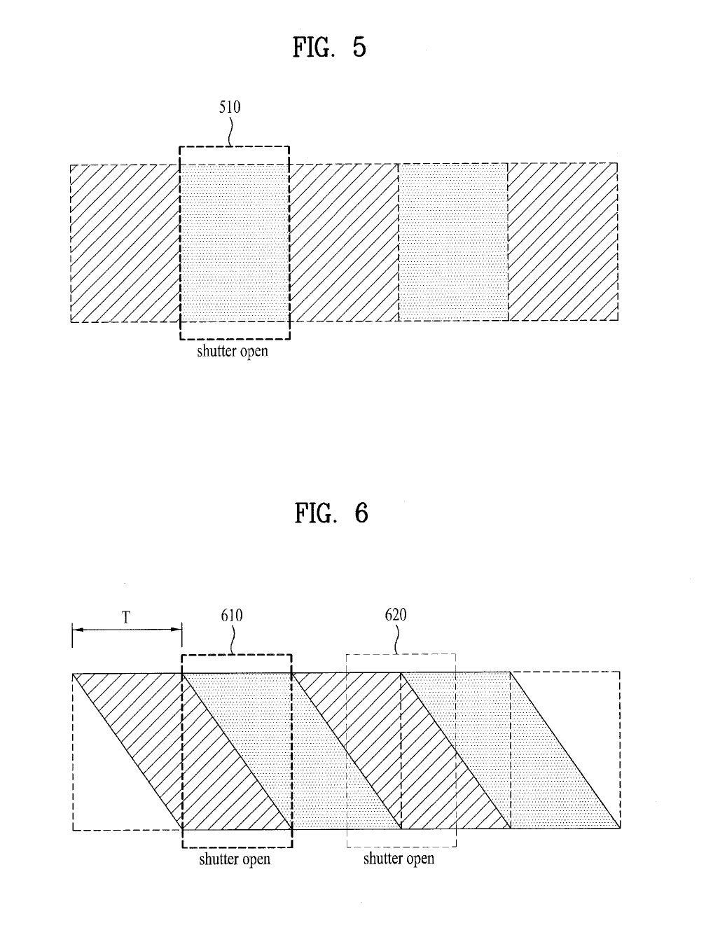

FIGS. 4 to 6 are conceptual diagrams illustrating a correlation between each display device and crosstalk according to embodiments of the present invention. FIG. 4 shows a correlation between crosstalk and a CRT display device. FIG. 5 shows a correlation between crosstalk and a Plasma Display Panel (PDP) or Digital Light Processing (DLP) display device. FIG. 6 shows a correlation between crosstalk and a Liquid Crystal Display (LCD) display device. In addition, each dotted line box (e.g., 401, 402, 403, 404, or 405 of FIG. 4, 5, or 6) indicates one display screen of each display device, where an X axis means a time axis and a Y axis means a vertical position.

The crosstalk of the CRT display device shown in FIG. 4 will hereinafter be described in detail.

Referring to FIG. 4, ‘T’ means a light maintenance time acquired when a fluorescent substance is excited by an electronic beam on the condition that light or an optical signal is sequentially spread from an upper part of the screen of the CRT display device with respect to a Y axis.

Left view image data having the light maintenance time ‘T’ and right view image data having the light maintenance time ‘T’ are displayed from an upper left part of the dotted line boxes 401 to 405 with respect to X and Y axes. Assuming that the CRT display device is of an impulse type and does not have the light maintenance time ‘T’, all previous image data (frame 1) is displayed on the screen with respect to X and Y axes, and then next image data (frame 2) is displayed on the screen, so that no crosstalk occurs. However, although image data of a next frame begins to be displayed from an upper part of the screen due to the presence of the light maintenance time ‘T’ as shown in FIG. 4, image data of a previous frame is continuously displayed on a lower part of the screen.

Therefore, when each shutter (i.e., a right shutter of FIG. 4) of the shutter glasses having a shutter open frequency equal to an output frequency of the display device is opened, crosstalk occurs in a lower part of the screen. A user who views a 3D image may view overlapped screen images or experience dizziness due to the occurrence of crosstalk, such that the user may experience discomfort with viewing a 3D image. However, the light maintenance time ‘T’ of the CRT display device is relatively short, such that not much crosstalk occurs.

However, demand for CRT display devices is rapidly decreasing and unexpected problems occur in displaying a high resolution image on the CRT display device, so that CRT display devices are being rapidly replaced with the modern display devices such as LCDs, PDPs, DLPs, etc. Therefore, there is a need for the 3D image to utilize the latest display devices such as LCDs, PDPs, DLPs, etc. Detailed description of crosstalk in modern display devices is as follows.

Next, the crosstalk generated in a PDP and DLP shown in FIG. 5 will hereinafter be described in detail.

Referring to FIG. 5, in the case of using the PDP and the DLP, a single frame is displayed on the entire screen of the PDP or DLP according to operation principles of the PDP or DLP. Accordingly, almost no crosstalk, caused by mixing of the left image and the right image, is generated. However, in the case where a PDP actually has a long decay time of a fluorescent substance, some parts of a previous frame are continuously displayed into a next frame, so that crosstalk occurs.

Finally, the crosstalk generated in an LCD shown in FIG. 6 will hereinafter be described.

Referring to FIG. 6, the LCD is a hold type display device in a different way from the CRT shown in FIG. 4. Accordingly, ‘T’ shown in FIG. 6 is much longer than that of FIG. 4. In the case where a reference time point for opening each shutter of the shutter glasses that has the same frequency as that of a display device is set to a start time of each frame (See ‘610 ’) such that each shutter is opened at the start time of each frame, a previous frame is continuously displayed on several parts of the screen so that much crosstalk caused by a mixture of left and right images occurs.

In this case, if it is assumed that the above-mentioned shutter open reference time point is exemplarily changed to another shutter open reference time point 620, the degree of crosstalk is greatly reduced as compared to the above-mentioned case. However, it can be easily recognized that the crosstalk shown in FIG. 6 is very higher than that of the CRT display device shown in FIG. 4. That is, much crosstalk occurs in the LCD according to LCD operation principles as shown in FIG. 6, such that many problems occur in displaying a 3D image according to the frame sequential scheme based on the shutter glasses. Such problems occur because the light maintenance time ‘T’ of the LCD is much longer than that of the CRT display device. In addition, a difference between the light maintenance time ‘T’ of the LCD and the other light maintenance time ‘T’ of the CRT display device is based on the basic principles of the respective display devices. That is, the LCD device is of a hold type in a different way from the CRT display device, such that the LCD device is very unfavorable in terms of crosstalk.

A method for reducing crosstalk problems will hereinafter be described using the LCD device among display devices for displaying a 3D image as an example.

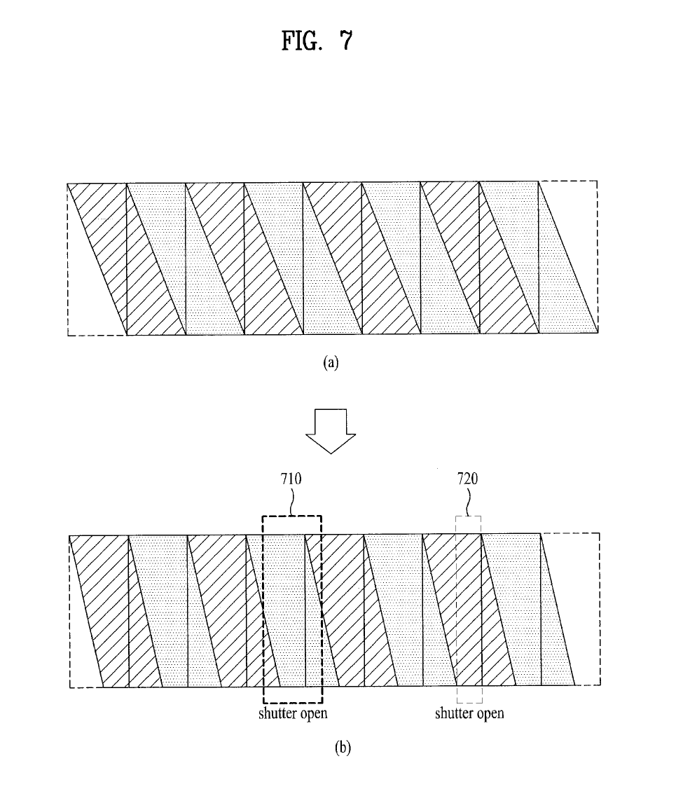

FIG. 7 is a conceptual diagram illustrating a method for improving crosstalk generated in an LCD display device according to embodiments of the present invention.

Hereinafter, the term ‘refresh rate’ indicates a rate at which the display module receives image data, and the term ‘pixel clock’ indicates a speed at which the display module writes or records received image data. At this time, it is assumed that both the refresh rate and the pixel clock of the display module shown in FIG. 6 are set to 60 Hz.

FIG. 7 shows a method for improving the crosstalk problem by adjusting the refresh rate and the pixel clock. For example, FIG. 7(a) shows an exemplary case in which the refresh rate of the display module is further adjusted as compared to that of FIG. 6. FIG. 7(b) shows an exemplary case in which both the refresh rate and the pixel clock shown in FIG. 6 are adjusted.

The method shown in FIG. 7(a) will hereinafter be described. The refresh rate shown in FIG. 7(a) is double the refresh rate of 60 Hz in FIG. 6, so that the refresh rate of FIG. 7(a) is increased to 120 Hz. Therefore, in the case where the shutter open frequency of the shutter glasses is set to 120 Hz and each shutter is opened for a time shorter than that of FIG. 6, crosstalk shown in FIG. 7(a) is greatly improved as compared to the crosstalk shown in FIG. 6.

In FIG. 7(b), the refresh rate is increased to 120 Hz in the same manner as in FIG. 7(a), and the pixel clock is increased from 60 Hz to 172 Hz. As a result, in the case where the shutter open frequency of the shutter glasses is set to 120 Hz and each shutter is opened at the frequency of 120 Hz as shown in reference number 710, the crosstalk shown in FIG. 7(b) is greatly improved as compared to FIGS. 6 and 7(a). In this case, provided that the shutter open frequency is set to 172 Hz and each shutter is then opened as shown in reference number 720, individual shutter open time points are programmed in a manner that crosstalk shown in FIG. 7(b) is further improved as compared to that of the shutter open frequency of 120 Hz, and thus almost no crosstalk occurs in the entire screen.

However, if it is assumed that the shutter open time of the shutter glasses is reduced as described above, the luminance may be deteriorated and a flicker phenomenon may be occurred by external illumination. Therefore, the shutter open time of the shutter glasses cannot be indefinitely reduced for crosstalk without considering the luminance and the flicker phenomenon, and an appropriate shutter open time should be determined. In addition, if the pixel clock frequency is set to 172 Hz, a display module for 120 Hz needs to be reconstructed.

Hereinafter, a method for processing an image signal (or a video signal) to minimize the crosstalk, the luminance deterioration, and the flicker phenomenon will be described in detail.

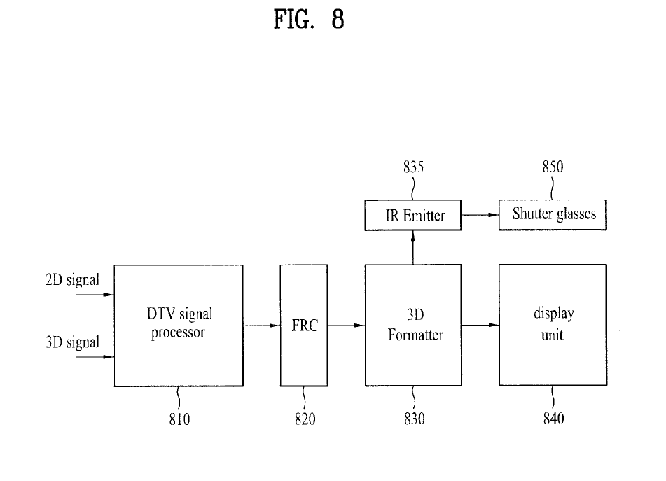

FIG. 8 is a block diagram illustrating a system for processing an image signal according to embodiments of the present invention.

Referring to FIG. 8, the system for processing the image signal includes a DTV signal processor 810, a Frame Rate Converter (FRC) unit 820, a 3D formatter 830, and a display unit 840.

The DTV signal processor 810 takes charge of primary processing of input image data. For example, the DTV signal processor 810 may be a DTV receiver for processing a digital broadcast signal. In this case, the primary processing, as distinguished from 3D image data processing (to be described later), is arbitrarily defined to minimize the crosstalk and the luminance deterioration of the 3D image data. For example, the above-mentioned primary processing may include a process for tuning a specific channel to receive a digital broadcast signal including image data, a process for receiving the digital broadcast signal via the tuned channel, a process for demodulating and demultiplexing the received digital broadcast signal, and a process for decoding image data from the demultiplexed digital broadcast signal. In association with the present invention, the DTV signal processor 810 receives and processes not only 3D image data but also 2D image data. Therefore, if the DTV signal processor receives the 2D image data instead of the 3D image data, the 2D image data is bypassed through only the 3D formatter 830 to be described later, so that the DTV signal processor 810 can be operated in the same manner as in a conventional DTV.

Hereinafter, a method for allowing the DTV signal processor 810 to process the 3D image data to be received after the primary processing will hereinafter be described in detail. In this case, the DTV signal processor 810 divides a received image into left image data and right image data, processes the left image data and the right image data in the form of a frame, and outputs the processed result.

The FRC unit 820 performs processing of the input image signal to correspond to an output frequency of the display unit 840. For example, if it is assumed that a frequency of an image signal output from the DTV signal processor 810 is set to 60 Hz and an output frequency of the display unit 840 is set to 120 Hz or 240 Hz, the FRC unit 840 performs processing of the above-mentioned image signal (60 Hz) according to a predefined method in a manner that the 60 Hz image signal can correspond with an output frequency 120 Hz or 240 Hz. In this case, a variety of methods may be used as the above-mentioned predefined scheme, for example, a method for temporally interpolating an input image signal and a method for repeating (or duplicating) only a frame of the image signal.

For convenience of description and better understanding of the present invention, it is assumed that a frequency of an input image signal is exemplarily set to 60 Hz, and a display frequency or an output frequency is exemplarily set to 240 Hz. However, it should be noted that the scope of the display frequency is not limited thereto and can be set to other frequencies as necessary. The term ‘display frequency’ or ‘output frequency’ allows 3D image data configured by the 3D formatter 830 to be output to the display unit 840. In the case of using the output frequency or the display frequency, the IR emitter 835 receives information of the display frequency or information of the output frequency from the 3D formatter 830, and transmits the received information to the shutter glasses 850, such that the shutter glasses 850 can be synchronized with the display frequency or the output frequency.

The temporal interpolation method divides a 60 Hz image signal into four equal parts (i.e., 0, 0.25, 0.5, and 0.75), so that a 240 Hz image signal is formed.

The above-mentioned method for repeating (or duplicating) the frame repeats each frame of the 60 Hz image signal three times, so that a frequency of each frame becomes a frequency of 240 Hz.

The above-mentioned methods are properly selected according to an input 3D image format, such that the selected method can be executed in the FRC unit 820.

The 3D formatter 830 configures an arrangement of 3D image data that has been processed in response to an output frequency by the FRC unit 820 into a 3D format serving as an output format.

The 3D formatter 830 outputs the configured 3D image data to the display unit 840, generates a synchronous signal (V sync) associated with stereoscopic image data having the configured arrangement in a manner that the output 3D image data is synchronized with the shutter glasses 850, and outputs the synchronous signal (V sync) to an Infrared Rays (IR) emitter 835, so that the user can view the 3D image data through the shutter glasses 850 according to display synchronous of the shutter glasses 850. In addition, the 3D formatter 830 may change some frames configuring 3D image data to black frames. The term ‘change’ may comprise a meaning of ‘replace’. The black frame is composed of black data. The term ‘black data’ may indicate another data different from actual image data configuring a 3D image. In accordance with the present invention, such data may be adapted to reduce crosstalk phenomenon. For this purpose, the black data may be used to reduce crosstalk. The black data or the black frame may be contained in a 3D image signal that may be generated in the receiver or be transmitted from the transmitter, and the resultant 3D image signal including the black data or black frame may be transmitted. Although the embodiment of the present invention has disclosed that the 3D formatter 830 processes the black data or the black frame, the scope and spirit of the present invention are not limited thereto, and can also be applied to other components or elements (e.g., the FRC unit 820 and the like) contained in the receiver as necessary.

The IR emitter 835 receives the synchronous signal (V sync) generated from the 3D formatter 830, and outputs the received synchronous signal to a light receiving unit (not shown) contained in the shutter glasses 850. The shutter glasses 850 adjust the shutter open period in response to the synchronous signal received via the IR emitter 835 after passing through the light receiving unit, such that it can be synchronized with stereoscopic image data generated from the display unit 840.

Although the FRC unit 820 and the 3D formatter 830 are configured as different modules in FIG. 8, it should be noted that the FRC unit 820 and the 3D formatter 830 may be integrated as one module.

Functions of individual constituent components of the reception system have been briefly described. The above-mentioned functions will hereinafter be described along with a method for configuring 3D image data.

Two exemplary methods of a method for configuring 3D image data according to embodiments of the present invention will hereinafter be described in detail, for example, a first method for configuring 3D image data according to a variation in arrangement of image data and a second method for configuring 3D image data using a backlight scan function.

First, the first method for configuring 3D image data according to a variation in arrangement of image data will hereinafter be described in detail.

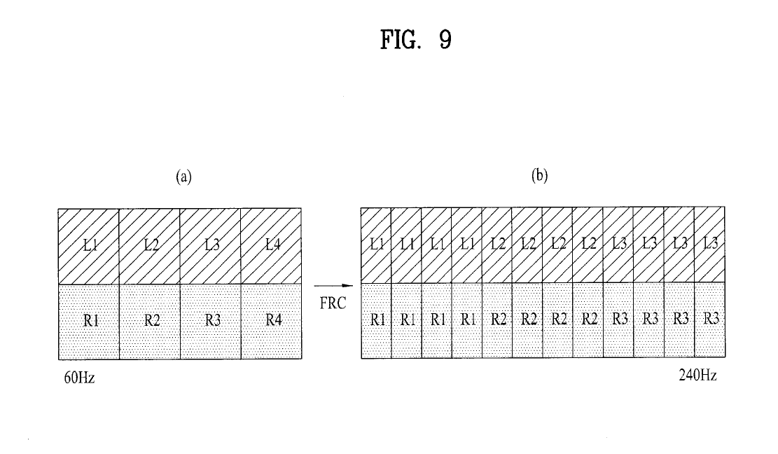

FIG. 9 is a conceptual diagram illustrating a method for processing 3D image data in the FRC unit 820 according to embodiments of the present invention. For convenience of description and better understanding of the present invention, although the 3D image data will be described using image data based on the top/down scheme as an example, the scope of the 3D image data is not limited thereto, it should be noted that the 3D image data can be applied to all schemes disclosed in FIGS. 1 and 2.

Referring to FIG. 9, FIG. 9(a) shows image data of an input specific frequency (e.g., 60 Hz), and FIG. 9(b) shows image data of an output frequency (or display frequency) (e.g., 240 Hz) which is generated from the display unit 840 after passing through the FRC unit 820. In more detail, as shown in FIG. 9(a), the 60 Hz input image data based on the top/down scheme includes four frames L1/R1, L2/R2, L3/R3, and L4/R4 in a top/down format. Referring to FIG. 9(b), the 60 Hz image data is processed in the FRC unit 820 on the basis of the output frequency of the display unit 840, so that the above top/down-based image data of 60 Hz is changed to top/down-based image data of 240 Hz. That is, FIG. 9(b) includes four L1/R1 parts, four L2/R2 parts, four L3/R3 parts, and four L4/R4 parts. In this case, the structure shown in FIG. 9(b) may be equally applied to all the methods described in the FRC unit 820.

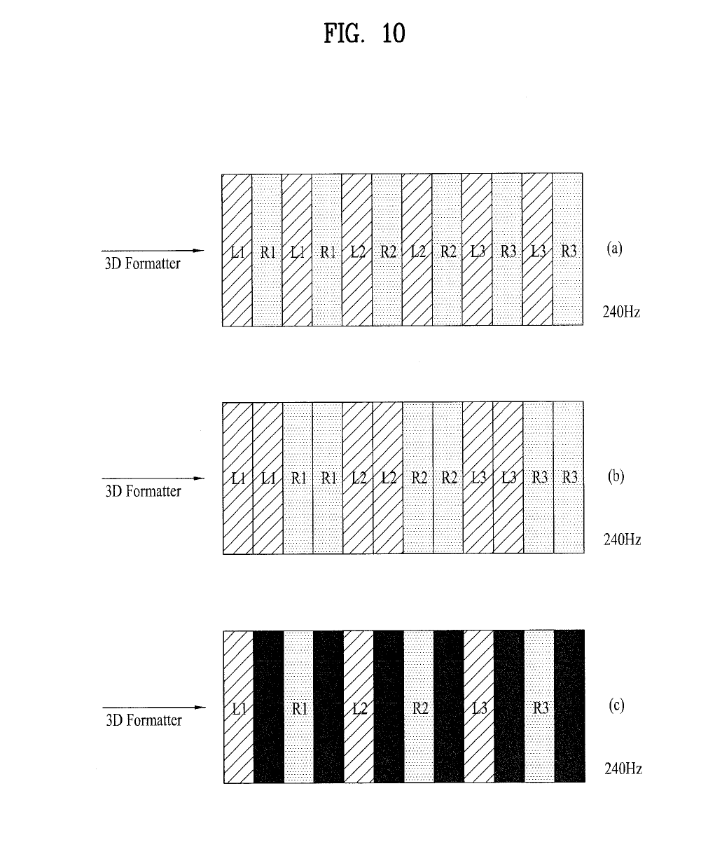

FIG. 10 is a conceptual diagram illustrating a method for configuring 3D image data according to one embodiment of the present invention.

Referring to FIG. 10, the 3D formatter 830 configures 3D image data in a manner that the shutter glasses 850 have the same effect as in the output frequency using a shutter open period having a frequency relatively lower than the output frequency of the display unit 840. For example, if the output frequency is set to 240 Hz, a user wearing the shutter glasses 850 having the shutter open period of 120 Hz may feel as if 3D image data were displayed at the frequency of 240 Hz instead of the frequency of 120 Hz.

Referring to FIG. 10(a), the top/down scheme-based 3D image data having passed through the 3D formatter 830 may have an arrangement ‘L1 R1 L1 R1 L2 R2 L2 R2 L3 R3 L3 R3’.

For example, as shown in FIG. 10(a), left view image data L and right view image data R of individual frames shown in FIG. 9(b) are sequentially and alternately output. Referring to FIG. 9(b), 12 frames from a 1st frame (L1/R1) to the 12th frame (L3/R3) are arranged in the direction from the left to the right. Therefore, in FIG. 10(a), L1 image data is selected from the first frame (L1/R1), R1 image data is selected from the second frame (L1/R1), L1 image data is selected from the third frame (L1/R1), and R1 image data is selected from the fourth frame (L1/R1), so that 3D image data is formed. If the remaining frames are also processed by the above-mentioned scheme and 3D image data is configured, 3D image data having the arrangement shown in FIG. 10(a) is configured.

Referring to FIG. 10(a), the top/down scheme-based image data having passed through the 3D formatter 830 may have an arrangement ‘L1 L1 R1 R1 L2 L2 R2 R2 L3 L3 R3 R3’.

For example, differently from FIG. 10(a), as shown in FIG. 10(b), left view image data (L) and right view image data (R) are sequentially and alternately selected and output in units of two successive frames shown in FIG. 9(b). Referring to FIG. 10(b), L1 image data is selected from each of the first frame (L1/R1) and the second frame (L1/R1) so that the L1-L1 format is formed. R1 image data is selected from the third frame (L1/R1) and the fourth frame (L1/R1) so that the R1-R1 format is formed. L2 image data is selected from each of the fifth frame (L2/R2) and the sixth frame (L2/R2) so that the L2-L2 format is formed. R2 image data is selected from the seventh frame (L2/R2) and the eighth frame (L2/R2) so that the R2-R2 format is formed. As a result, 3D image data is formed as shown in FIG. 10(b). If the remaining frames are also processed by the above-mentioned scheme and 3D image data is configured, 3D image data having the arrangement shown in FIG. 10(b) is configured.

In this case, in accordance with the arrangement structure of FIG. 10(b), the same image data is repeated in successive frames as shown in the L1-L1 or R1-R1 format, a user can view 3D image data using the shutter glasses 850 having a shutter open period (e.g., 120 Hz) shorter than that of an output frequency (e.g., 240 Hz) where the display unit 840 outputs 3D image data, resulting in a minimum number of problems with regard to crosstalk and luminance.

Referring to FIG. 10(c), the top/down scheme-based image data having passed through the 3D formatter 830 may have an arrangement ‘L1 BF R1 BF L2 BF R2 BF L3 BF R3 ’. In this case, ‘BF’ is an abbreviation for Black Frame, and means that image data of a corresponding frame is black data.

In other words, FIG. 10(c) shows that the black frames (BFs) are used but one in a different way from FIG. 10(a) and FIG. 10(b). For instance, each black frame is inserted between two frames (L1R1) in the structure of FIG. 10(a), so that the arrangement of FIG. 10(c) may be configured. Alternatively, if either one of two successive frames (L1-L1) including the same image data is replaced with a black frame (BF) in FIG. 10(b), the arrangement of FIG. 10(c) may be configured. As a result, a black frame (BF) is located between left image data and right image data in the structure of FIG. 10(c), resulting in the prevention of crosstalk.

In this case, the arrangement structure of FIG. 10(c) arranges one black frame (BF) every other frame (i.e., every second frame) as denoted by ‘L1 BF R1 BF . . . ’, such that a user can view 3D image data using the shutter glasses 850 having a shutter open period (e.g., 120 Hz) shorter than that of a display frequency (e.g., 240 Hz) where the display unit 840 displays 3D image data, resulting in a minimum number of problems with regard to crosstalk and luminance.

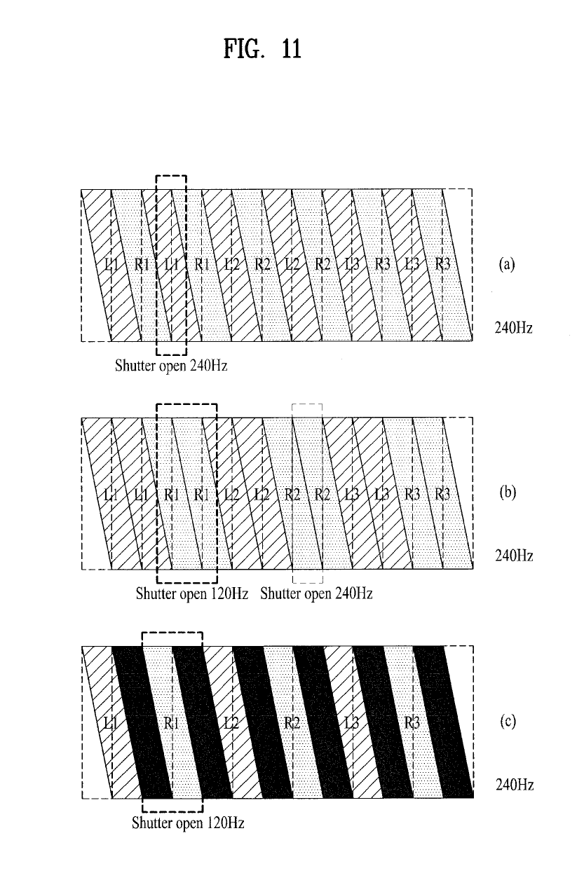

FIG. 11 is a conceptual diagram illustrating a method for displaying 3D image data having arrangements shown in FIGS. 10(a) to 10(c) according to one embodiment of the present invention. For convenience of description and better understanding of the present invention, it is assumed that FIG. 11(a) corresponds to FIG. 10(a), FIG. 11(b) corresponds to FIG. 10(b), and FIG. 11(c) corresponds to FIG. 10(c).

Referring to FIGS. 10(a) and 11(a), 3D image data having the arrangement of FIG. 10(a) is displayed according to characteristics of a display device after passing through the display unit 840. In this case, each of the frames may have a frequency of 240 Hz. Also, there may be a need for the shutter open frequency of the shutter glasses to be set to the frequency of 240 Hz, because left image data and right image data are alternately arranged at intervals of the period 240 Hz. At this time, the shutter open time may be programmed in a manner that crosstalk is minimized, so that the crosstalk phenomenon can be greatly reduced.

Referring to FIGS. 10(b) and 11(b), 3D image data having the arrangement of FIG. 10(b) is displayed according to characteristics of a display device after passing through the display unit 840. In this case, each of the frames may have a frequency of 240 Hz. However, in this case, the shutter open frequency of the shutter glasses 850 may be operated at a frequency lower than a display frequency. In more detail, if it is assumed that the display frequency is 240 Hz, the user can view a 3D image by driving the shutter glasses 850 at a shutter open frequency of 120 Hz lower than the display frequency of 240 Hz, because frames having the same image data are successively or consecutively arranged. In this case, although the shutter open frequency of the shutter glasses may be driven at 120 Hz and crosstalk is generated, there is little difference between the generated crosstalk and the crosstalk generated in FIG. 10(a). In the case where the shutter open frequency is set to 240 Hz as shown in a right dotted-lined part, there is a need for the shutter open time to be programmed in a manner that crosstalk is minimized, and the problem of luminance deterioration may also occur.

Referring to FIGS. 10(c) and 11(c), 3D image data having the arrangement of FIG. 10(c) is displayed according to characteristics of a display device after passing through the display unit 840. In this case, each of the frames may have a frequency of 240 Hz. However, as can be seen from FIG. 11(c), the shutter open frequency of the shutter glasses 850 can be operated at a frequency lower than a display frequency in the same manner as in FIG. 11(b). The dotted line part of FIG. 11(c) shows that the shutter open frequency of the shutter glasses is set to 120 Hz. In FIG. 11(c), a section in which crosstalk is originally generated is filled with black data, so that crosstalk of FIG. 11(c) is minimized as compared to those of FIGS. 11(a) and 11(b). In contrast, the structure shown in FIG. 11(c) has a disadvantage in that it has a lower luminance level as compared to those of FIGS. 11(a) and 11(b).

In association with the programming disclosed in the above-mentioned cases, the 3D formatter 830 may exemplarily generate a control signal, and transmit the control signal to the shutter glasses 850 after passing through the IR emitter 835.

The above-mentioned description has disclosed the method for constructing 3D image data.

In the following description, a method for constructing image data using a backlight scan function pre-stored in the display unit 840, without using the 3D formatter 830 will be described with reference to the annexed drawings.

The above-mentioned method relates to a method for configuring 3D image data output from the display device according to one embodiment of the present invention. Next, a method for achieving the objective of the present invention by controlling a display device (e.g., a backlight unit) according to another embodiment of the present invention will hereinafter be described in detail. The method for controlling the backlight unit is classified into a backlight blinking method and a backlight scanning method. Detailed description of the backlight blinking method and the backlight scanning method is as follows. However, information about the 3D image data configuration quotes the above-mentioned description without any change for convenience of description and better understanding of the present invention, and as such and as such a detailed description thereof will be omitted herein for convenience of description.

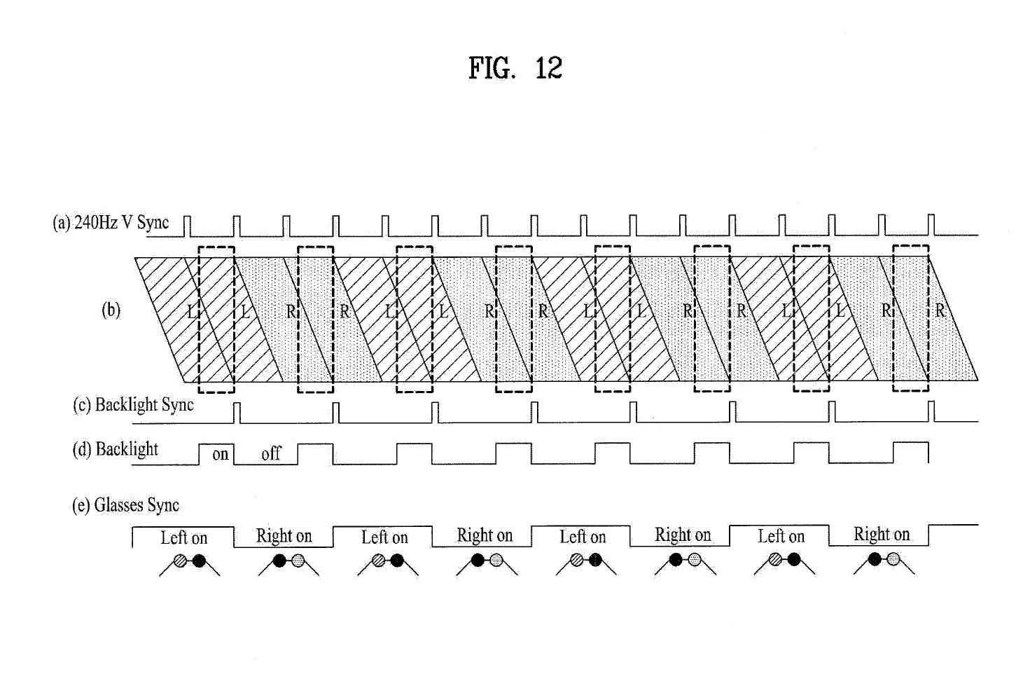

FIG. 12 shows an example of a backlight control method according to one embodiment of the present invention. The backlight control method shown in FIG. 12 is designed to power on or off the backlight unit at a predetermined time point.

FIG. 12(a) shows a synchronous signal (V sync) of an output frequency through which the display unit 840 outputs 3D image data. However, for convenience of description and better understanding of the present invention, although the output frequency is synchronized with the frequency of 240 Hz, the scope and spirit of the present invention are not limited thereto, and synchronization of various output frequencies such as 120 Hz may also be included in the scope of the present invention.

FIG. 12(b) shows 3D image data that is output in response to a synchronous frequency (240 Hz V Sync) of the output frequency shown in FIG. 12(a).

FIG. 12(c) shows synchronization (Backlight Sync) of a control signal for powering on or off the backlight unit (i.e., the backlight control). FIG. 12(d) shows a method for powering on or off the backlight unit in response to synchronization of the control signal shown in FIG. 12(c).

FIG. 12(e) shows a medium for allowing a user to view 3D image data. For example, FIG. 12(e) shows synchronization of the shutter glasses (Shutter glasses Sync).

An exemplary backlight control method according to the present invention will hereinafter be described with reference to FIG. 12.

For convenience of description and better understanding of the present invention, the output 3D image data may have a frame structure configured in LLRRLLRR . . . format, and the backlight control may be designed in a manner that the backlight unit is powered on either at a specific time point or at a specific synchronous signal. However, the scope and spirit of the present invention are not limited thereto, and can also be applied not only to various frame structures but also to a method for controlling the backlight unit to be powered off. In addition, as to the frame structure of the LLRRLLRR . . . format shown in FIG. 12, although the above-mentioned backlight control method controls the backlight unit to be powered on at the location of a second L frame from among the overlapped or repeated frames (e.g., LL), the backlight control method may also control the backlight unit to be powered on at a first L frame.

Image data that is formatted or configured in a 3D format by the 3D formatter 830 is output according to the synchronization (240 Hz V sync) based the output frequency shown in FIG. 12(a). In other words, one frame is output in response to synchronization (240 Hz V sync) based on each output frequency.

However, under the condition that the backlight unit is not controlled at all as described above, although a left-eye glass and a right-eye glass are alternately turned on according to the synchronization of the shutter glasses shown in FIG. 12(e), if image data of a neighbor frame is different from image data of a corresponding frame, crosstalk unavoidably occurs. In order to prevent such crosstalk from being generated, a method for inserting the black frame between frames may be used as described above. The following description relates to a method for solving problems caused by crosstalk by controlling not the black frame but the backlight unit of the receiver.

Therefore, as shown in FIG. 12, the backlight unit is turned on according to each backlight synchronous signal (Backlight Sync). Generally, the backlight unit synchronization (Backlight Sync) needs to be lower than the output frequency synchronization (240 Hz V sync). For example, a synchronization frequency of the backlight unit is set to 120 Hz.

Therefore, the backlight unit controls a section, which is turned on according to a predetermined setup condition, according to the backlight unit synchronization (Backlight Sync). For example, a specific synchronization or specific time for powering on the backlight unit is predefined. The backlight unit is powered on at the defined specific synchronization or the defined specific time. Thereafter, the backlight unit powered on is then powered off according to the synchronization signal (Backlight Sync) of the backlight unit. Although the backlight-unit ON section is set to 240 Hz or less in FIGS. 12(b) and 12(d), it should be noted that the backlight unit may also be powered on another synchronous frequency of 120 Hz or may also be optionally defined.

As described above, the shutter glasses 850 may be synchronized with the synchronization of the display frequency (240 Hz V sync) in response to the synchronous signal transferred from the IR emitter 835. In FIG. 12, the shutter glasses 850 are operated as a frequency of 120 Hz. A left-eye glass and a right-eye glass of the shutter glasses 850 are alternately turned on according to the backlight unit synchronization (Backlight Sync).

As described above, the backlight control method according to the present invention controls the backlight unit, such that the user can view a 3D image from 3D image data having no crosstalk. For example, the backlight control method is referred to as ‘backlight blinking’.

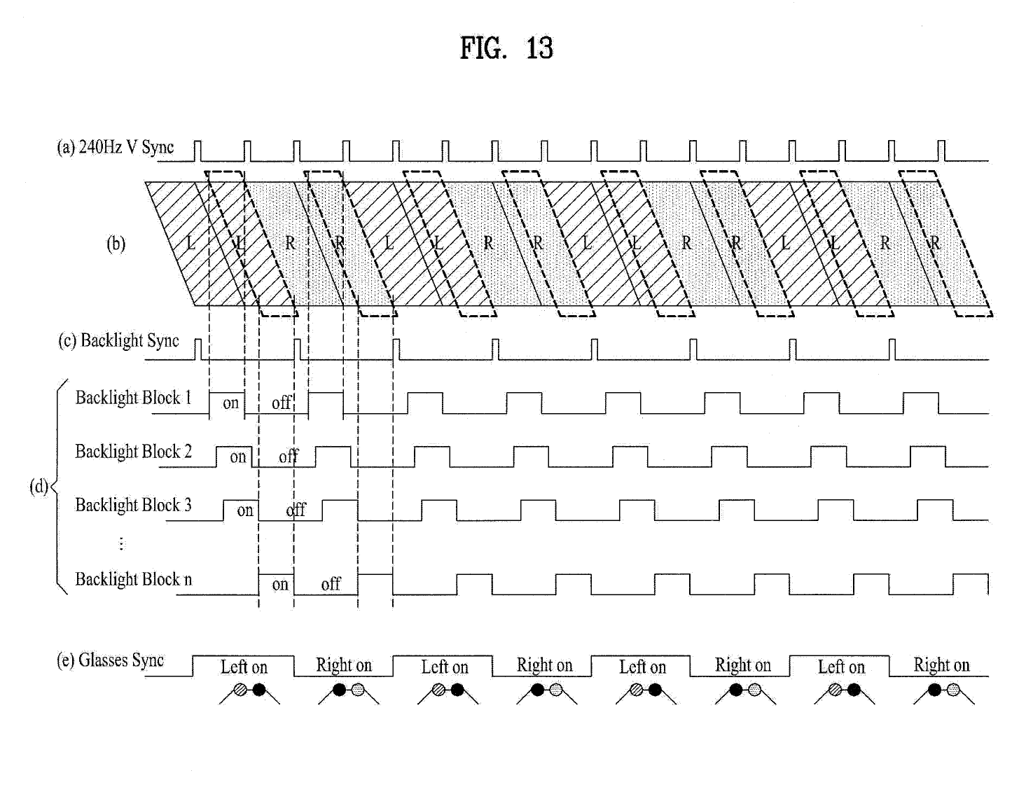

FIG. 13 shows another example of a backlight control method according to one embodiment of the present invention. The backlight control method shown in FIG. 13 is designed to power on or off the backlight unit at a predetermined time point. The backlight control method shown in FIG. 13 sequentially turns on or off each backlight block configuring the backlight unit capable of performing local dimming.

FIG. 13(a) shows a synchronous signal (V sync) of an output frequency through which the display unit 840 outputs 3D image data. However, for convenience of description and better understanding of the present invention, although the output frequency is synchronized with the frequency of 240 Hz, the scope and spirit of the present invention are not limited thereto, and synchronization of various output frequencies such as 120 Hz may also be included in the scope of the present invention.

FIG. 13(b) shows 3D image data that is output in response to a synchronous frequency (240 Hz V Sync) of the output frequency shown in FIG. 13(a).

FIG. 13(c) shows synchronization (Backlight Sync) of a control signal for powering on or off the backlight unit (i.e., the backlight control). FIG. 13(d) shows a method for powering on or off individual backlight blocks (1 to n) configuring the backlight unit in response to synchronization of the control signal shown in FIG. 13(c).

FIG. 13(e) shows a medium for allowing a user to view 3D image data. For example, FIG. 13(e) shows synchronization of the shutter glasses (Shutter glasses Sync).

An exemplary backlight control method according to the present invention will hereinafter be described with reference to FIG. 13.

For convenience of description and better understanding of the present invention, the output 3D image data may have a frame structure configured in LLRRLLRR . . . format, and the backlight control may be designed in a manner that individual backlight blocks (1 to n) configuring the backlight unit is powered on either at a specific time point or at a specific synchronous signal. However, the scope and spirit of the present invention are not limited thereto, and can also be applied not only to various frame structures but also to a method for controlling the backlight unit to be powered off. In addition, as to the frame structure of the LLRRLLRR . . . format shown in FIG. 12, although the above-mentioned backlight control method controls the backlight unit to be powered on at the location of a second L frame from among the overlapped or repeated frames (e.g., LL), the backlight control method may also control the backlight unit to be powered on at a first L frame.

Image data that is formatted or configured in a 3D format by the 3D formatter 830 is output according to the synchronization (240 Hz V sync) based the output frequency shown in FIG. 12(a). In other words, one frame is output in response to synchronization (240 Hz V sync) based on each output frequency.

However, under the condition that the backlight unit is not controlled at all as described above, although a left-eye glass and a right-eye glass are alternately turned on according to the synchronization of the shutter glasses shown in FIG. 13(e), if image data of a neighbor frame is different from image data of a corresponding frame, crosstalk unavoidably occurs. In order to prevent such crosstalk from being generated, a method for inserting the black frame between frames may be used as described above. The following description relates to a method for solving problems caused by crosstalk by controlling not the black frame but the backlight unit of the receiver. In addition, the embodiment shown in FIG. 12 may unexpectedly cause the limitation of a frame configuration according to a turn-ON section of the backlight unit. According to the backlight control method shown in FIG. 13, although L/R frames are alternately arranged at every frame in a manner of not the LLRR . . . format but the LRLR format, crosstalk phenomenon can be minimized.

Therefore, as shown in FIG. 13, individual backlight blocks (1 to n) configuring the backlight unit are sequentially turned on according to each backlight synchronous signal (Backlight Sync). Generally, the backlight unit synchronization (Backlight Sync) needs to be lower than the output frequency synchronization (240 Hz V sync). For example, a synchronization frequency of the backlight unit is set to 120 Hz.

Therefore, the backlight unit controls a specific section, wherein the backlight unit is turned on in response to a predetermined condition, according to synchronization of the backlight unit shown in FIG. 13(e). Referring to FIG. 13(d), for example, the first to n-th backlight blocks are sequentially turned on in the range between one backlight unit's synchronization (Backlight Sync) and the next backlight unit's synchronization (Backlight Sync). In this case, each backlight block may be turned on during a predetermined section starting from a specific time at which each backlight block is turned on. Then, each backlight block may be turned off until again receiving the ON control signal. In other words, if one frame L is output in response to synchronization of an output frequency, each backlight block is turned on at a corresponding time, resulting in no crosstalk.

As described above, the shutter glasses 850 may be synchronized with the synchronization of the display frequency (240 Hz V sync) in response to the synchronous signal transferred from the IR emitter 835. In FIG. 13, the shutter glasses 850 are operated as a frequency of 120 Hz. A left-eye glass and a right-eye glass of the shutter glasses 850 are alternately turned on according to the backlight unit synchronization (Backlight Sync).

As described above, the backlight control method according to the present invention controls the backlight unit, such that the user can view a 3D image from 3D image data having no crosstalk. For example, the backlight control method is referred to as ‘backlight scanning’.

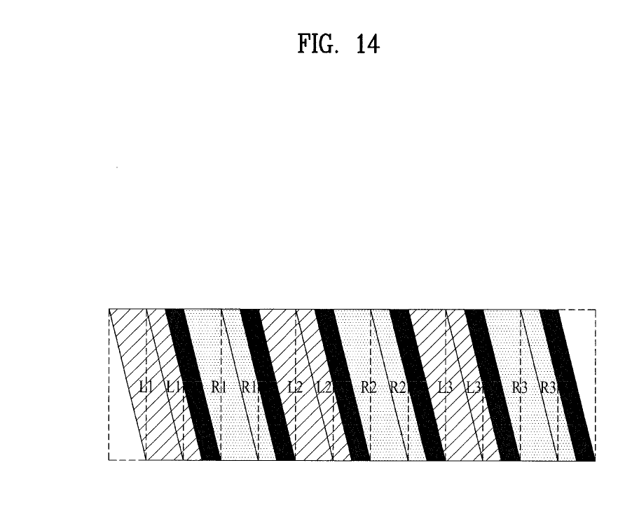

FIG. 14 shows another example of a method for controlling the backlight unit according to the present invention. In this case, although FIG. 14 is similar to FIG. 13, a method for controlling a plurality of backlight blocks configuring the backlight unit shown in FIG. 14 is different from that of FIG. 13.

Differently from FIG. 13, the backlight control method shown in FIG. 14 is characterized in that it does not control the powering on/off operations of all backlight blocks (1 to n) contained in the backlight unit, and controls only some backlight blocks. For example, the control of only some backlight blocks means that only the ½ frame is output on the basis of one frame and the remaining frame parts are controlled by the backlight unit, as can be seen from FIG. 14. For these purposes, backlight blocks of an output part from among several backlight blocks configuring the backlight unit are controlled to be turned on, and the remaining backlight blocks corresponding to the remaining parts are controlled to be turned off.

In FIG. 14, only the backlight blocks of the backlight unit corresponding to some parts of 3D output image data are controlled, such that redundancy may be given to 3D image data configuration and the efficiency of the 3D image data may also be increased.

Although the above-mentioned embodiment has exemplarily disclosed that backlight blocks corresponding to the ½ frame part are controlled, the scope and spirit of the present invention are not limited thereto, and can also be applied to other examples as necessary. The above-mentioned backlight blocks are programmed in various ways, and the backlight blocks of the corresponding part are controlled, such that crosstalk or luminance deterioration may be solved.

FIGS. 12 to 14 have disclosed method for controlling the backlight unit according to the present invention. The following description relates to a method for combining a method for employing the black frame with a method for controlling the backlight unit.

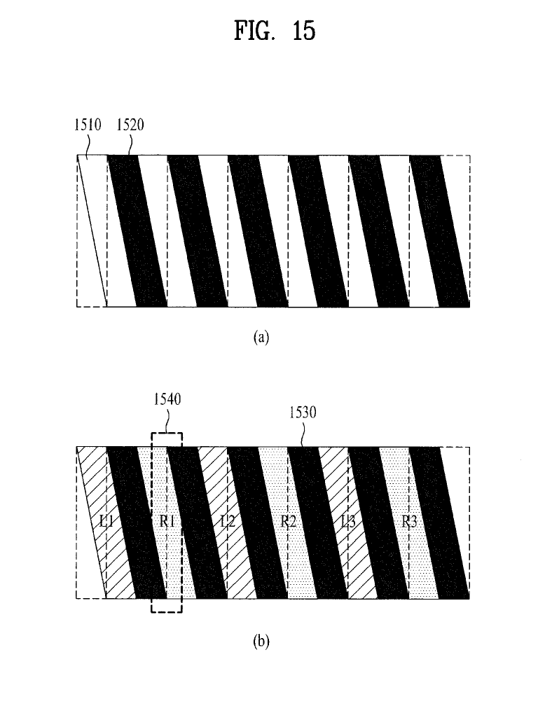

FIG. 15 is a conceptual diagram illustrating a method for constructing 3D image data according to yet another embodiment of the present invention.

In more detail, FIG. 15 shows a combination of an embodiment based on the black frame (BF) and another embodiment based on the backlight control function.

For convenience of description and better understanding of the present invention, it is assumed that 3D image data having arrangements of FIGS. 11(a) and 11(b) is configured. However, operations for constructing the arrangements (or configurations) of FIGS. 11(a) and 11(b) have already been disclosed, and as such a detailed description thereof will herein be omitted.

In accordance with the embodiment shown in FIG. 15, 3D image data having the arrangements of FIGS. 11(a) and 11(b) is arranged as in FIG. 11(c) including black frames (BFs). In other words, black frames (BFs) are inserted into the arrangement of FIG. 11(a) so that the arrangement of FIG. 11(c) can be formed. In the arrangement of FIG. 11(b), repeated frames are replaced with black frames (BFs) so that the arrangement of FIG. 11(c) can be formed.

Next, in this embodiment of the present invention, after the arrangement is formed in a manner that black frames (BFs) are included in a form of arrangement of FIG. 11(c), the backlight control operation is carried out as shown in FIG. 15(a). In this case, the even frame backlight unit 1510 is turned on, and the odd frame backlight unit 1520 is turned off. Accordingly, for example, the backlight control operation may be carried out at each BF position. In contrast, the backlight control operation may also be carried out in reverse order of FIG. 15(a).

In this way, if the backlight control operation is carried out as shown in FIG. 15(a), the arrangement of FIG. 15(b) is formed. Although the arrangement of FIG. 15(b) is similar to that of FIG. 11(c), it should be noted that the frame 1530 including a black frame (BF) in the arrangement of FIG. 15(b) is backlight-controlled whereas the arrangement of FIG. 11(c) has only black frames (BFs). In addition, the shutter open period 1540 of the shutter glasses is established as shown in FIG. 15(b), resulting in the prevention of problems in crosstalk and luminance.

Therefore, in accordance with the embodiment shown in FIG. 15, black frames (BFs) are inserted in the same manner as in FIG. 11, so that crosstalk can be greatly reduced. Also, afterimage and luminance problems caused by BF insertion can be improved by execution of a backlight control operation. In other words, the embodiment of FIG. 15 can reduce crosstalk of a 3D image while simultaneously improving luminance of the 3D image.

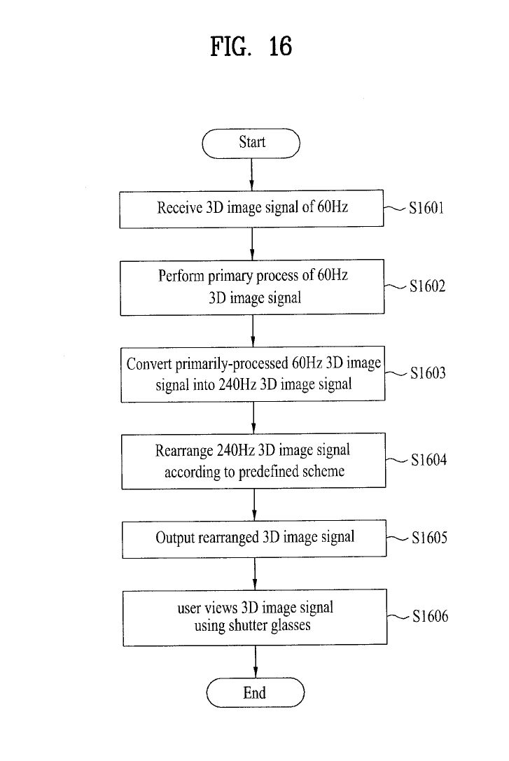

FIG. 16 is a flowchart illustrating a method for processing image data according to one embodiment of the present invention.

In more detail, FIG. 16 is a flowchart of a modified embodiment of the above-mentioned image data arrangement.

Referring to FIG. 16, the DTV signal processor 810 receives 3D image data at step S1601, and primarily processes the received 3D image data at step S1602. In this case, a frequency of the received 3D image data may be 60 Hz. Also, the above-mentioned primary process may include a process for demodulating, demultiplexing, and decoding 3D image data in the DTV signal processor 810.

The FRC unit 820 converts the primarily-processed 3D image data into 3D image data suitable for an output frequency of the display unit 840 at step S1603. For example, the FRC unit 820 may convert (or process) 3D image data of 60 Hz into 3D image data of 240 Hz indicating an output frequency.

The arrangement (or configuration) of the 240 Hz 3D image signal is changed to another arrangement according to the predefined scheme at step S1604. In this case, the predefined scheme may be set to any of FIGS. 10(b) and 10(c) as an example.

The display unit 840 outputs the 240 Hz 3D image data having the resultant arrangement changed by the predefined scheme at step S1605.

A user views the resultant 3D image data using the shutter glasses having the predefined shutter open period at step S1606. In this case, the predefined shutter open period may be set to 120 Hz or 240 Hz as an example.

By the execution of the above-mentioned steps, the user can view the improved 3D image data in which crosstalk and pixel luminance deterioration are minimized.

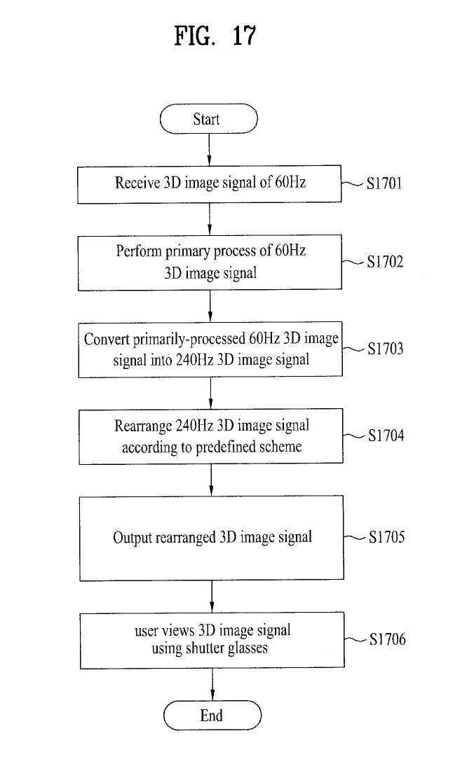

FIG. 17 is a flowchart illustrating a method for processing image data according to another embodiment of the present invention.

In more detail, FIG. 17 is a flowchart of an embodiment related to the above-mentioned backlight control function.

FIG. 17 shows the backlight control function that is carried out in the same manner as in FIG. 14(b). For convenience of description and better understanding of the present invention, only different parts other than the same or duplicated parts as those of FIG. 16 will hereinafter be described. In other words, steps S1701 to S1704 shown in FIG. 17 are similar to steps S1601 to S1604 shown in FIG. 16, and as such detailed description thereof will herein be omitted. In the following description, steps from step S1705 will be described.

When the display unit 840 outputs 240 Hz 3D image data having the arrangement having been changed by the predefined scheme, the backlight control function is performed on the 240 Hz 3D image data for a predetermined period in the same manner as in FIG. 12, 13, 14 or 15, so that the backlight-controlled 3D image data is output at step S1705.

The user can view the resultant 3D image data using the shutter glasses having a predefined shutter open period at step S1706. In this case, the predefined shutter open period may be set to 120 Hz or 240 Hz.

Various embodiments have been described in the best mode for carrying out the invention.

As apparent from the above description, in the case of using the 240 Hz LCD frame sequential stereoscopic scheme using active shutter glasses according to the above-mentioned image data processing method shown in the embodiments of the present invention, crosstalk can be greatly reduced and at the same time 3D image data having improved luminance can be displayed.

Embodiments of the present invention can effectively display 3D image data using the 240 Hz display module, the FRC unit, and the 3D formatter, and can minimize crosstalk generated in a stereoscopic image display using the backlight control function, resulting in the implementation of maximal luminance.

Although 2D image data except for 3D image data is received at an image data processing apparatus, the apparatus controls the 2D image data to be bypassed through the 3D formatter, so that the apparatus can process the 2D image data in the same manner as in the conventional 2D data processing method.

According to embodiments of the present invention, a method for processing 3D image data and an apparatus for receiving the 3D image data has the following effects. First, crosstalk generated in a process for displaying 3D image data can be greatly reduced. Secondly, the crosstalk can be reduced whereas the luminance can be increased.

Although the present invention has been described in conjunction with the limited embodiments and drawings, the present invention is not limited thereto. Those skilled in the art will appreciate that various modifications, additions and substitutions are possible from this description. Therefore, the scope of the present invention should not be limited to the description of the exemplary embodiments and should be determined by the appended claims and their equivalents.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of displaying an image, the method comprising:
receiving a three-dimensional (3D) image signal;
generating image data from the 3D image signal, wherein said image data includes a plurality of left image data and a plurality of right image data;
configuring the generated 3D image data to a 3D format, wherein the configured 3D image data includes black data; and
displaying the configured 3D image data an output frequency, wherein the output frequency is synchronized with a shutter glasses.

2. The method of claim 1 further comprises controlling a power of a backlight unit.

3. The method of claim 2, wherein the step of controlling the power of the backlight unit is performed at some part of a period being displayed 3D image data.

4. The method of claim 3, wherein the some part can be overlapped with a part of displaying the black data.

5. The method of claim 2, wherein the step of controlling the power of the backlight unit is performed by any one of a backlight scanning and a backlight blinking.

6. A method of displaying an image, the method comprising:
receiving a three-dimensional (3D) image signal;
generating image data from the 3D image signal, wherein said image data includes a plurality of first image data and a plurality of second image data;
configuring the generated 3D image data to a 3D format;
displaying the configured 3D image data at an output frequency, wherein the output frequency is synchronized with a shutter glasses; and
controlling a power of a backlight at some part of a period being displayed 3D image data.

7. The method of claim 6, wherein the configured 3D image data includes black data.

8. The method of claim 7, wherein the generated black data is configured for configured 3D format.

9. The method of claim 7, wherein the some part of a period being displayed 3D image data can be overlapped with the black data.

10. The method of claim 6, wherein the step of controlling the power of the backlight unit is performed by any one of a backlight scanning and a backlight blinking.

11. A method of displaying an image, the method comprising:
receiving an image signal by a signal processor;
processing the image signal into a left image data and a right image data;
processing the left image data and right image data into a frame;
generating a plurality of frames based upon the frame;
formatting the generated plurality of frames into at least one left frames and at least one right frames;
displaying the formatted at least one left frames and the formatted at least one right frames;
controlling a power of a backlight at some part of a period being displayed the at least one left frames and at least one right frames; and
synchronizing a frequency of a user glasses with a frequency of the displayed at least one left frames and at least one right frames.

12. The method of claim 11, wherein one of the left frames is a frame having black data and one of the right frame having black data.

13. The method of claim 12, wherein the displayed the formatted at least one left frames and the formatted at least one right frames become substantially black of the black frames of the right frames and the left frames.

14. An apparatus of processing three-dimensional (3D) image data, the apparatus comprising:
a receiving unit for receiving a 3D image signal;
a Frame Rate Converter (FRC) unit for generating image data from the 3D image signal, wherein the image data includes a plurality of first image data and a plurality of second image data;
a formatter for configuring the generated 3D image data to a 3D format, wherein the configured 3D image data includes black data; and
a display unit for displaying the configured 3D image data at an output frequency, wherein the output frequency is synchronized with a shutter glasses.

15. The apparatus of claim 14 further comprises a controller for controlling a power of a backlight unit in the display unit.

16. The apparatus of claim 15, wherein the controller controls to be performed at some part of a period being displayed 3D image data.

17. The apparatus of claim 16, wherein the controller controls the some part of a period being displayed 3D image data to be overlapped with a part of displaying the black data.

18. An apparatus of processing three-dimensional (3D) image data, the apparatus comprising:
a receiving unit for receiving a 3D image signal;
a Frame Rate Converter (FRC) unit for generating image data from the 3D image signal, wherein said image data includes a plurality of first image data and a plurality of second image data;
a formatter for configuring the generated 3D image data to a 3D format;
a display unit for displaying the configured 3D image data at an output frequency, wherein the output frequency is synchronized with a shutter glasses; and
a controller for controlling a power of a backlight at some part of a period being displayed 3D image data.

19. The apparatus of claim 18, wherein the controller controls the configured 3D image data to include black data.

20. The apparatus of claim 19, wherein the controller controls the some part of a period being displayed 3D image data to be overlapped with a part of displaying the black data.
